(19) United States
(12) Patent Application Publication
(10) Pub. No.: US 2015/0081496 A1
(43) Pub. Date: Mar. 19, 2015

(54) System and Method for an Integrated Financial Management Tool

(71) Applicant: STATE FARM MUTUAL AUTOMOBILE INSURANCE COMPANY, Bloomington, IL (US)

(72) Inventors: Jeffrey Clayton Rowe, Normal, IL (US); Dana Louise Kafer, Fairbury, IL (US); Holly Yourgans, Bloomington, IL (US)

(73) Assignee: STATE FARM MUTUAL AUTOMOBILE INSURANCE COMPANY, Bloomington, IL (US)

(21) Appl. No.: 14/031,954

(22) Filed: Sep. 19, 2013

(51) Int. Cl. G06Q 20/22

(52) U.S. Cl. CPC G06Q 20/227
USPC 705/35

(57) ABSTRACT

A system and method for integrating and facilitating customer experience provides a user a one-stop location for acquisition of products and services, servicing of products and services, transaction processing, and internal and external financial account management. Once a user registers an individual customer during an activation session, which may include entry of that customer's internal or external account information, the system manages multiple accounts for the customer in accordance with system and user defined rules providing a means to acquire and service products and services, as well as to receive disbursements to external accounts from the system. The system also includes a rules system which scans and resolves any conflicts created among system rules.

### TECHNICAL FIELD

This disclosure is directed to a system and method for integrating and facilitating customer experience, specifically, acquisition of products, servicing of products, transaction processing, and internal and external financial account management.

### BACKGROUND

Commonly, customers of a company, such as an insurance company, have financial resources spread across accounts at multiple financial institutions or vendors. A certain customer might have a checking account at a local bank, a retirement account through an employer, a money market through a brokerage firm, etc. As a result, customers often need to supply, modify, or update account information every time they wish to complete a transaction with the company. Even in cases where some account information is stored with the company, customers often need to maintain up-to-date records of account information in multiple online locations (e.g., multiple web-based dashboards) corresponding to multiple different products and/or services offered by the company. Such a disconnected, or fragmented, customer experience causes confusion on the part of the customer and/or on the part of representatives of the company, financial institutions, or third party vendors. In some cases, such a customer experience causes unexpected or even costly mistakes.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

In one aspect the invention features an integrating and facilitating customer experience system (“the system”) and method (“the method”) which includes receiving a user request for an interaction requiring access to at least one financial account, using a rule-based account determination module (a module made up of at least one rule) at a processor executed on a server for determining at least one recommended financial account stored in a database, transmitting and displaying a list of the at least one recommended financial account, receiving from the user a selection of at least one financial account from the list of at least one recommended financial account(s) and using a rule-based account verification module for verifying the eligibility of the at least one financial account for use with the interaction. If the at least one account is eligible, the interaction is processed by accessing the selected account. If the at least one account is not eligible, the user may be prompted for entry of a new account. A “user” of the system may be a customer, a potential customer, or a customer service representative. A “customer account” may be the account of a customer or a potential customer.

Embodiments may include one or more of the following features. The system and method may include receiving information that indicates one or more source or target accounts that the user desires to use during the interaction. If a payment is desired, the method may include receiving information indicating one or more source accounts to which the user desires the transfer of funds if the balance of the account exceeds the desired payment amount. If a disbursement is desired, the method may include receiving information indicating one or more target accounts to which the user desires the transfer of funds.

The system and method may also include implementing rule-based modules based on the information received from the user in the interaction request, and information related to relevant financial accounts stored on a database. The method may include a user notification message indicating a transfer of funds into or out of an account. The method may also include transferring funds into or out of the account on a certain date.

In another aspect the invention features the integrating and facilitating customer experience system and method for automatically managing a customer financial profile of at least one account of a user maintained at one or more third party institutions that includes receiving information from the user indicating a minimum level at which balance of the account is to be maintained, storing the minimum balance value in a memory device, periodically retrieving account data about the customer financial account from the third party institution, pre-populating account information for the user during subsequent interactions and requests for interactions, retrieving the minimum balance value stored in memory, comparing the current balance of the account to the minimum account value, and transferring funds into the account sufficient to raise the balance to or above the minimum account value if the current balance is below the minimum account value.

Another aspect of the invention features a system that includes a database configured to store account information, an aggregation system configured to retrieve account related information, and a rules engine configured to create rule-based modules to cause, amongst other things, a transfer of funds from source accounts and to target accounts during interactions involving acquiring or servicing of products and services. The rules engine may also be configured to create rule-based modules which allow accounts to be used as a source account during one interaction, and a target account during another interaction. In addition, the rules engine may be configured to permit a user to acquire products, service products including accommodating appropriate discounts (e.g., safe driver discount, home security system discount, etc.) and process transactions (e.g., disbursements including claim payouts or dividends, payments) in one location.

Another aspect of the invention features the integrating and facilitating customer experience system and method for managing a portfolio of customer financial accounts of a user maintained at multiple financial institutions or vendors. The system and method includes receiving data indicating the user's preference for maintaining a minimum balance in a first account at a first financial institution, monitoring the balance of the first account, and transferring funds to or from an account when the user wishes to acquire products, service products and process transactions. The rules engine may further be configured to cause a transfer of funds from the second account to the first account if the current balance of the first account is less than or greater than the payment amount requested. The method may include receiving information indicating the user's desire to schedule a future transfer of funds from an account to acquire a service or product or to automatically receive funds when a service or product is scheduled to disburse.

The method may further include transmitting a message to the user indicating the transfer of funds from the account to acquire or pay for a service or product. The method may, prior to transferring funds, transmit to the user a message suggesting the transfer of funds from account.

The method may further include transmitting a message to the user indicating the transfer of funds to the account upon disbursement of a service or product. The method may, prior to transferring funds, transmit to the user a message suggesting the transfer of funds to the account.

Embodiments may also include one or more of the following features. The method may also include through an organization's maintenance services prompting the user for information should any of the financial accounts need attention due to expiration or any other errors which would prevent a transaction.

Conventionally, customer experience with organizations (e.g., companies, corporations, entities, service providers, etc.) which sell a wide diversity of products and services in which a customer may acquire more than one of those products and services, and in which the customer has a relationship with the organization through the ongoing servicing of those products and services, is fragmented. Customers typically have accounts across multiple institutions including accounts with the organizations with which they have a relationship involving ongoing servicing of those products and services. In order to acquire or service the products and services offered by the organization or to access other business applications related to the organization, the customer must repeatedly enter information from separate accounts resulting in errors and a less than optimal customer experience including lost time attempting to access multiple account information. The integrating and facilitating customer experience system and method addresses the problems common in the conventional fragmented customer experience.

Other advantages and features of the invention will be apparent from the following description and from the claims.

### BRIEF DESCRIPTION OF THE DRAWINGS

FIG. 1 illustrates an example environment in which a financial account system can be implemented.

FIG. 2 illustrates an example financial account system which can be implemented in the environment illustrated in FIG. 1.

FIG. 3 is a list of eight common interactions with a financial account system such as the financial account system illustrated in FIG. 2.

FIG. 4 is an example screenshot depicting the option to add a credit or debit card to a financial account system such as the financial account system illustrated in FIG. 2.

FIG. 5 is an example screenshot depicting the option to add a bank account to a financial account system such as the financial account system illustrated in FIG. 2.

FIG. 6 is an example screenshot depicting the option to view an individual bank account that is part of a financial account system such as the financial account system illustrated in FIG. 2.

FIG. 7 is an example screenshot depicting the option to view a customer(s) portfolio of accounts that are part of a financial account system such as the financial account system illustrated in FIG. 2.

FIG. 8 is an example screenshot depicting the option to remove an account from a customer's portfolio of accounts in a financial account system such as the financial account system illustrated in FIG. 2.

FIG. 9 is a flow diagram of an example method for adding an account to a financial account system such as the financial account system illustrated in FIG. 2.

FIG. 10 is a flow diagram of an example method for managing rules associated with an account in a financial account system such as the financial account system illustrated in FIG. 2.

FIG. 11 is a flow diagram of an example method for operating a financial account system such as the financial account system illustrated in FIG. 2.

### DETAILED DESCRIPTION OF THE INVENTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

As used herein, a “financial account” or an “account” includes any asset account, such as checking, savings, brokerage, money market, 401(k)s, IRAs, whole life insurance policies, annuities, or the like, as well as any liability account, such as mortgages, car loans, student loans, customer loans, utility accounts, home equity lines, or the like. As used herein, the term “financial institution” as used in this description refers to any individual, company, corporation, partnership, government entity, or any other entity that maintains a customer financial account, and includes such entities as banks, brokerage companies, mutual fund companies, credit unions, life insurance companies, mortgage companies, loan service companies, utility companies, and companies that manage pensions or 401(k) accounts. Also, as used herein, “Products” and “services” may involve car insurance, life insurance, renters insurance, home insurance, banking, business insurance, etc.

An integrated financial account system allows a customer of a company, such as an insurance or other service company, to manage all financial accounts used for payments to the company and disbursements from the company. The customer may access a single online location, such as a single authenticated website, to update, add, revise, or otherwise interact with financial account information. As such, customers may acquire new products or services, process disbursements (e.g., insurance claims), etc. at the central online location without a need for updating and maintaining multiple versions of financial account information.

The financial account system receives requests from a user (e.g., a customer or a potential customer) and provides the user with access to multiple verified internal and external accounts via a financial account management tool displayed on a user device. Subsequently, the user may utilize one or more of the accounts to acquire products and services and/or modify currently owned products and/or services (e.g., service an existing insurance policy). In addition, the user may update, revise, add, etc. financial account information via the financial account management tool.

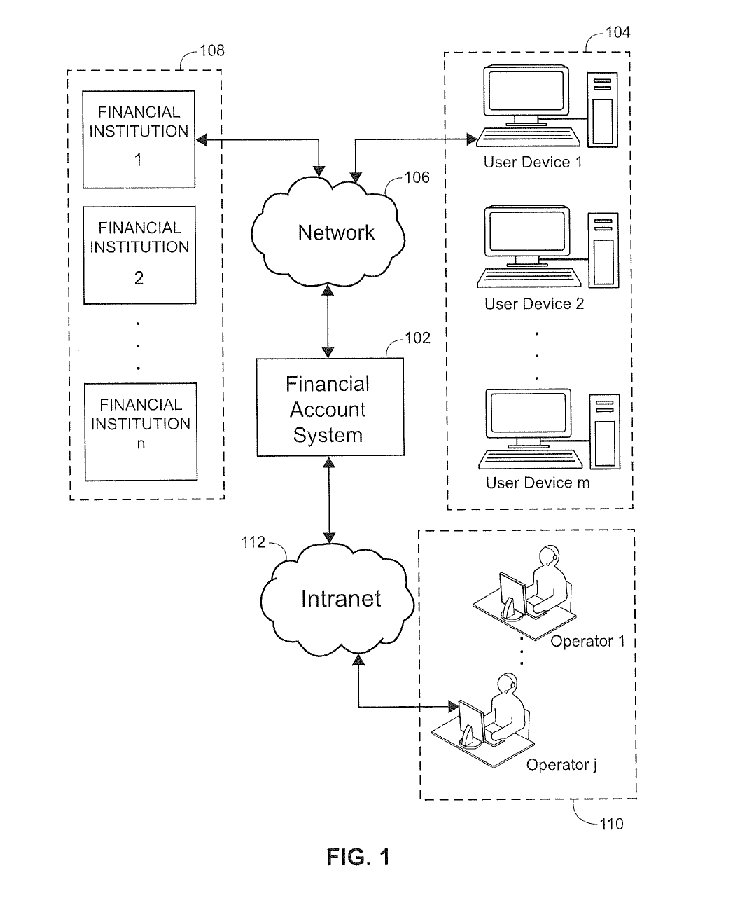

FIG. 1 illustrates an example environment 100 including a financial account system 102 capable of allowing customers, or users, to access and manage financial account information. The environment 100 includes a plurality of user devices 104 (“User Device 1”—“User Device m”) communicatively coupled to the financial account system 102 via a network 106, where the network 106 may be any suitable mobile or wide area network (e.g., the Internet). The plurality of user devices 104 may include smartphones, laptop/desktop computers, tablet computers, etc., for example. In addition, a plurality of financial institutions 108 (e.g., banks, credit card companies, etc.) are communicatively coupled to the financial account system 102 (“Financial Institution 1”—“Financial Institution n”) via the network 106.

In an implementation, the plurality of end user devices 104 are capable of executing a graphical interface (GUI) for a financial account management tool within a web browser application, such as Apple's Safari®, Google Android ™ mobile web browser, Microsoft Internet Explorer®, etc. The web browser application may be implemented as a series of machine-readable instructions for receiving, interpreting, and displaying web page information from a web server (not shown) while also receiving inputs from the user. Further, those skilled in the art will recognize that the present system can be used in a dedicated application in addition to a web browser.

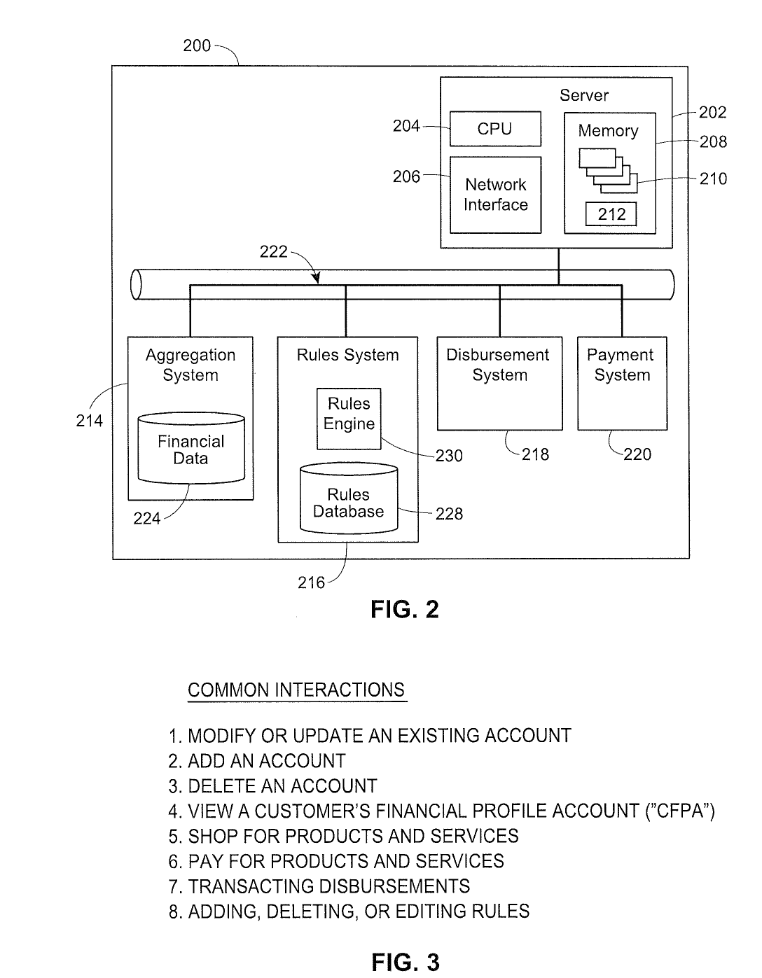

The financial management system 102 of the environment 100 may include one or more servers with a number of software applications responsible for generating financial account management content to be included in the web pages sent to the plurality of end user devices 104. For example, the financial management system 102 may generate forms, financial account summaries, payment authorization statements, etc., as discussed below, to be included in the web pages sent to the plurality of user devices 104. Further details of the price financial management system 102 are discussed with reference to FIG. 2.

In addition, the example environment 100 includes a plurality of operator terminals 110 communicatively connected to the financial account system 102 via an intranet 112. The intranet 112 may be a proprietary network, a virtual private network or some other type of network, such as dedicated access lines, plain ordinary telephone lines, satellite links, combinations of these, etc. By way of example, an operator of one of the plurality of operator terminals 110 may be: (1) a customer service representative who may assist the user in interacting with the financial account system 102, and may or may not provide advice to the user, or (2) a licensed broker or financial advisor who may or may not provide financial advice to the user while assisting the user in utilizing or configuring the financial account system 102. Also, an operator of one of the plurality of operator terminals 110 may have access to a telephone (not shown) and/or facsimile machine (not shown) to communicate with a user, in an implementation.

FIG. 2 illustrates an example financial account system 200 which may be implemented in the example environment 100. The financial account system includes a server 202 with a CPU 204, a network interface 206, and a memory 208. The memory 208 may store a number of software applications 210, as discussed with reference to FIG. 1, and a financial account management routine 212. The financial account management routine 212 may be executed by the CPU 204 to process requests from users and/or financial institutions related to updating, revising, verifying, etc. financial account information. Although illustrated with one server 202 in FIG. 2, financial account systems may include any suitable number of servers to process requests from user and distribute financial account management content to users.

The server 202 is communicatively connected to an aggregation system 214, a rules system 216, a disbursement system 218, and a payment system 220 via a local network 222. Although FIG. 2 illustrates four systems 214, 216, 218, and 220 communicatively connected to the server 202, any suitable number of systems, databases, engines, etc. may be communicatively connected to the server 202. Further, the tasks performed by multiple of the systems 214, 216, 218, and 220 may be combined into tasks performed by a single system or server, in an implementation.

The server 202 may communicate with the disbursement system 218 and the payment system 220 to allow the financial account system 200 to transfer money between financial accounts, as well as, to or from one or more companies via requests sent from customers to the financial account system 200, in an implementation. The disbursement system 218 and the payment system 220 may be electronic money transfer systems or on-line check writing system, in an implementation.

The server 202 may utilize the aggregation system 214 to periodically (e.g., once per day) retrieve and store customer financial data for each customer in a customer financial database 224. For each customer, the financial database 224 includes account information from financial accounts of the customer regardless of which financial institution maintains the account, in an implementation. For example, if a customer maintains a checking account at Bank of America™, a money market account at Fidelity Investments™, and a mortgage account at FannieMae™, the financial database 224 may include account information about all three accounts. In some implementations, the account information stored within the financial database 224 includes a complete record of all transactions (claims processing, payments, disbursements including claim payouts or dividends) on one or more accounts, such as those transactions processed by the disbursement system 218 and/or the payment system 220. In other implementations, the financial database 224 may include a record of all transactions on one or more accounts for a limited time period only (e.g., all transactions within the past three months). In still other configurations, the financial database 224 may simply maintain the current balance of one or more accounts.

The rules system 216 includes a rules database 228 and a rules engine 230. In an implementation, the rules system 216 may be utilized by the server 202 to maintain an/or define rules specifying how the financial account system 200 is to manage financial accounts. Managing financial accounts may include processing interaction involving the acquisition of products, servicing of products, processing of transactions (e.g., disbursements, payments/payouts), or any other business applications. Once the rules system 216 specifies a set of rules stored in the rules database 228, the financial account system 200 may automatically manage multiple accounts across multiple financial institutions in accordance with the rules, in an implementation.

Each customer interaction with the financial account system 200 involves pre-determined rules either defined by the system as a default (e.g., by the company operating the financial account system 200), or by the customer, in an implementation. For example, a company operating the financial account system 200 may allow a customer to access, add, delete and edit default rules established by the financial account system, such as rules defining which accounts are to used for certain future transactions or rules defining a recurring payment or disbursement plan from an external financial institution. The rules system 216 may also, in some implementations, have a protocol to handle conflicting rules (e.g., always prioritize customer-defined rules above default rules).

In an embodiment, a financial account system, such as financial account system 200, may handle a variety of interactions between customers, one or more companies, and the financial account system itself. Interactions are not necessarily mutually exclusive and system usage may include several interactions, or even duplicate interactions, during a single session of user interaction with a financial account management tool, such as the financial account management web pages described with reference to FIG. 1. By way of example, FIG. 3 is a list of eight common interactions.

In one scenario, an interaction may include modifying or updating a financial account. For example, a user may wish to modify account information stored in an financial database, such as financial database 224. Reasons for such modification may include recent changes to customer information, account expiration, recent changes to an affiliated institution associated with an account, etc.

In another scenario, an interaction with a financial account system may include adding a new account to the financial account system. For example, a user device, such as one of the user devices 104, may send a request to a financial account system, including necessary account information, to add a financial account to the financial account system, thus permitting usage of the newly added account for future transactions. In some implementation, adding a financial account includes establishing a communicative link (e.g., defining a network server location and authentication) with a corresponding external financial institution or vendor, such as a bank, credit card company, etc.

In some embodiments, adding a new account to a financial account system may include account verification. For example, financial account system may determine that an account is current, includes accurate information, is not considered fraudulent, and may be used for a future transaction as part of an account verification process. Such a process may involve communication with both internal and external company/institution representatives or computer systems.

Similarly, an interaction with a financial account system may include deleting a financial account already recorded and maintained in the financial account system (e.g, in financial database 224). Reasons for such a deletion may include a change in customer information, account expiration, etc.

In yet another scenario, an interaction with a financial account system may include viewing a financial profile corresponding to a customer. The financial profile, or customer financial profile account (“CFPA”), may include up-to-date information about all of the accounts in the financial account system, for example. Also, in some implementations, the CFPA may include one or multiple accounts, which may be internal financial accounts, such as accounts used only for transactions within a company operating the financial account system, or external financial accounts, such as accounts used for transactions with a company operating the financial account system and transactions with companies or financial institutions external to the company operating the financial account system.

In still another scenario, an interaction with a financial account system may include shopping for products and services (e.g., life insurance products) offered by the company maintaining the financial account system. The financial account system may generate web page content, for example, to display all available products and services with respect to the CFPA of a customer or the needs indicated by a customer. In other words, the financial account system may display all relevant information that a customer needs to execute a transaction, or other interaction. In one implementation, an interaction including shopping for products and services does not require information about financial accounts and may be directed via user interaction/requests.

Further, the financial account system may cause pre-populated financial profile information, such as account balances, to be displayed on a user device during a “shopping” interaction. Pre-populated information may be sourced from the aggregated financial database, for example.

In another scenario, an interaction with a financial account system may include payment for products and services using one or more available financial accounts. For example, the financial account system may process payments at any suitable time, such as a predetermined time, scheduled time, repeated or periodic time, future request time, etc. Both a company operating the financial account system and the customer interacting with the financial account system may customize payment instructions, in an implementation.

In yet another scenario, an interaction with a financial account system may include transacting a disbursement (e.g., a dividend) to one or more selected, available, and verified accounts. Disbursements can be programmed to be one-time, scheduled, repeated, disbursed a future customer request, etc., for example. Both a company operating the financial account system and a customer interacting with the financial account system may customize disbursement transactions, in an implementation.

Generally speaking, customer or company interactions with a financial account system can be any of: viewing a financial profile, making a purchase, requesting a quote, receiving a disbursement, making a new policy purchase, making a policy change, opening a new bank account, making a change to a bank account, applying for a new loan, making a change to a loan, making a loan payment, applying for a new credit card, interacting with PayPaI™, making a change to a credit card account, making a credit card payment, opening a new mutual fund account, making a change to a mutual fund account, opening a new money market account, making a change to a money market account, initiating automated clearing house (ACH) type transactions, opening a new retirement account, making a change to a retirement account, making a deposit, making a withdrawal, submitting a fraud report, or reporting claims activity. This list is given by way of example and not limitation. Each customer, or potential customer, interacting with a financial account system, via one of the plurality of user devices 104, for example, may access a customer “dashboard” web page displaying at least some of following example content: (1) policies and accounts with a company operating the financial account system (these are the products and services offered by the organization); (2) payments and transfers associated with policies, such as insurance policies, and accounts; (3) pending or past claims associated with the policies and accounts; (4) saved internal and external financial accounts for payments or disbursements. The dashboard page may also provide interactive features such as immediate or delayed access to customer service, options to print relevant documents, access to customer profile information, options for presentation in additional languages, access to drop down navigation menus, etc.

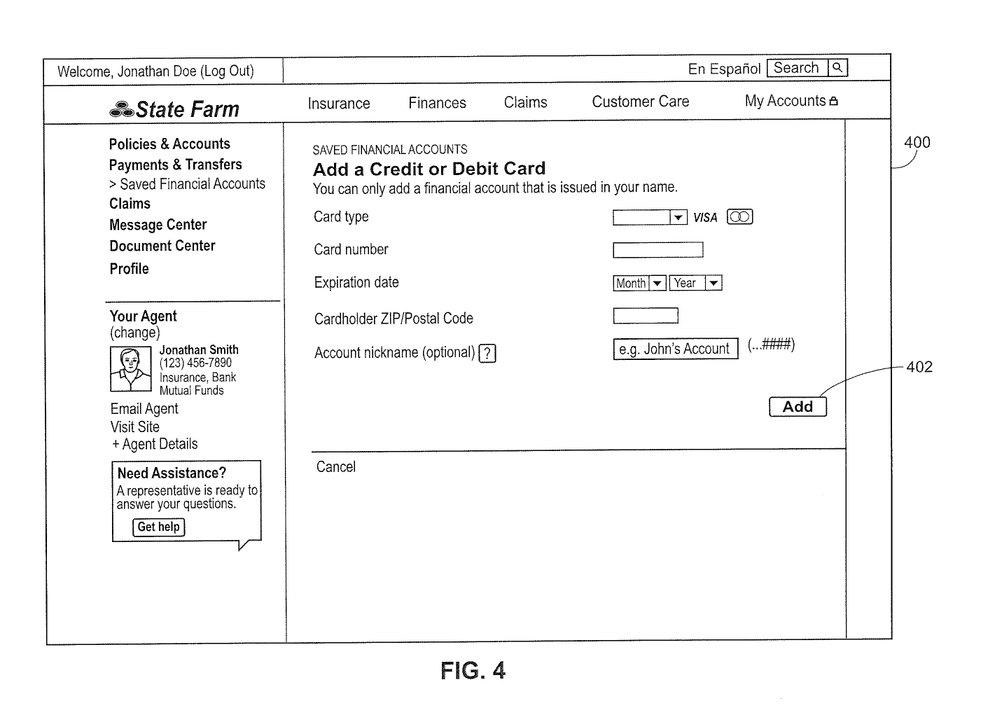

FIG. 4 is a screenshot of an example dashboard page 400, displayed on a user device, in which a customer may add a credit or debit card to the CFPA corresponding to the customer, an interaction discussed further with respect to FIG. 3. Since the account that is desired to be added to the system is a debit or a credit card, information that may be entered via the dashboard page 400 includes a card type, the card number, an expiration date, a cardholder zip code, and an optional account nickname. When a user has entered the appropriate information, the user may click, tap, or otherwise select an add button 402 to add the account to the CFPA.

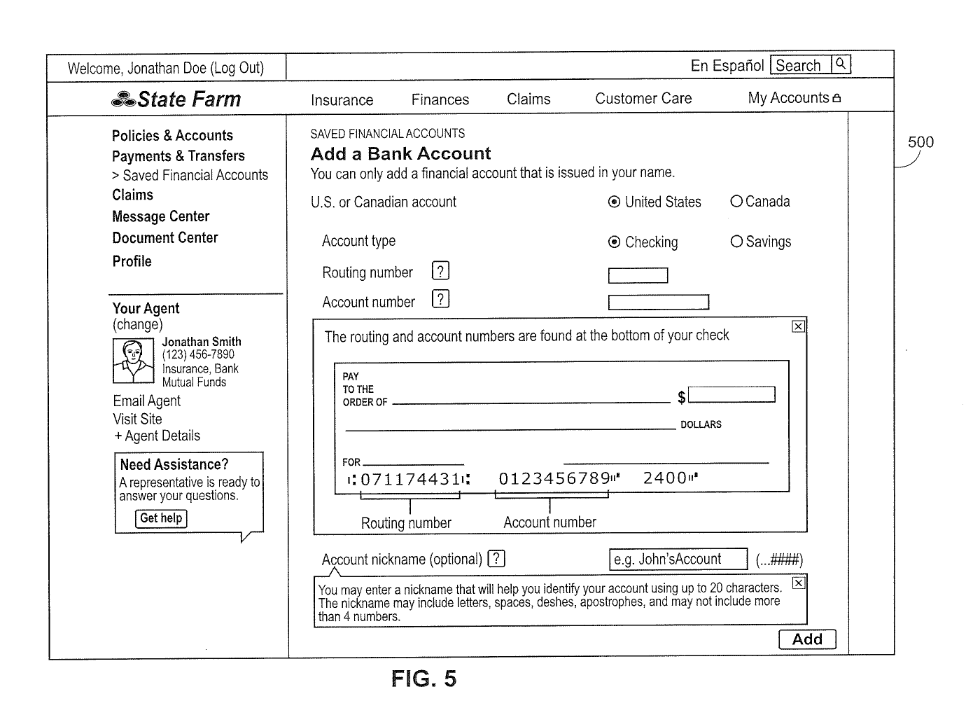

Similarly, FIG. 5 is a screenshot of an example dashboard page 500 in which a customer may add a bank account to the CFPA corresponding to the customer. Since the account that is desired to be added to the system is a bank account, information that may be entered via the dashboard page 500 includes an account type, a routing or transit (not shown) number, an account number, and an optional account nickname.

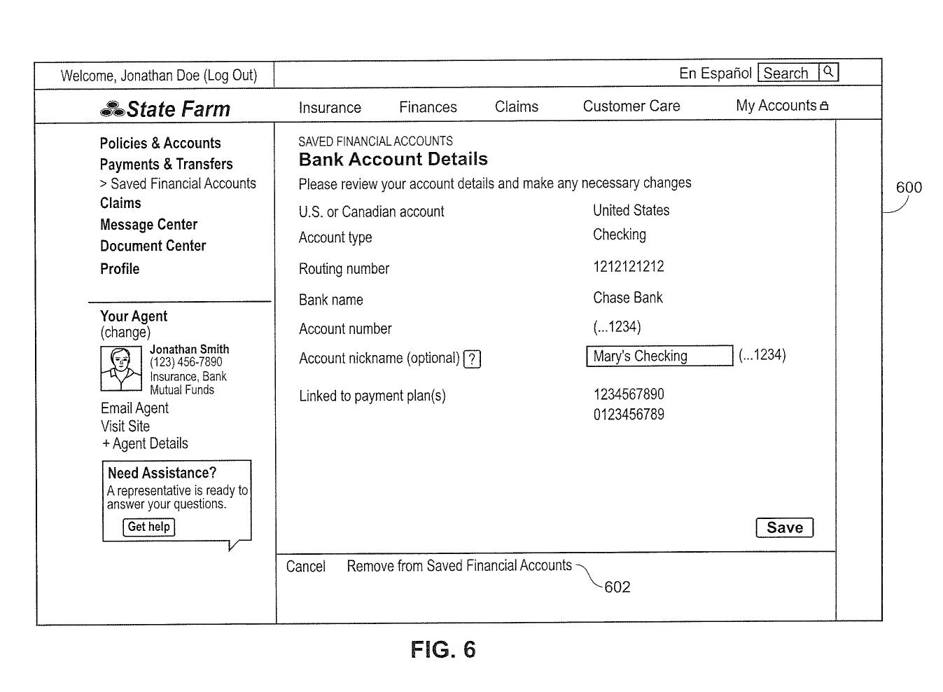

FIG. 6 is a screenshot of an example dashboard page 600 in which a single account in a CFPA is summarized for customer review. The dashboard page 600 may display a country in which the account exists (ex. US or Canada), an account type, a routing number, a bank name, an account number, a nickname, and a linked payment or disbursement (not shown) plan. Also, the example dashboard page 600 may allow a user to remove the summarized account from the corresponding CFPA (e.g., by selecting the option 602).

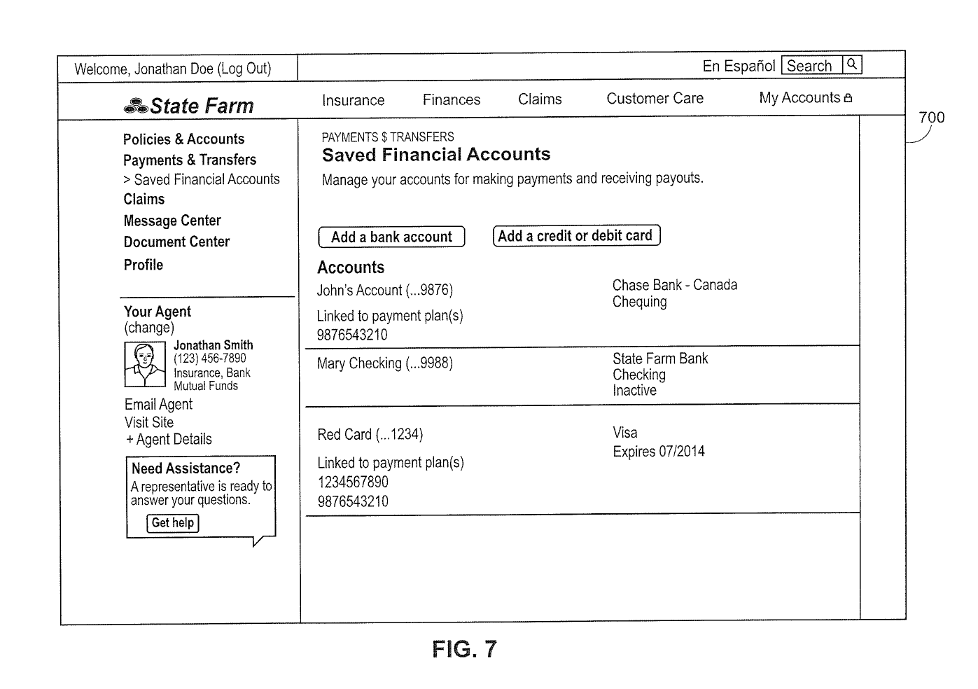

FIG. 7 is a screenshot of another example dashboard page 700 in which all accounts in a CFPA are summarized for customer review. The example dashboard page 700 includes information corresponding to multiple accounts and corresponding link information including the payments plans to which the accounts are linked. In some implementation, a dashboard page may include accounts belonging to more than one individual associated with the CFPA. For example, as illustrated in FIG. 7, the dashboard 700 includes “John's Account” with Chase and “Mary Checking” associated with different individuals who may be related via family, or other relevant, connections.

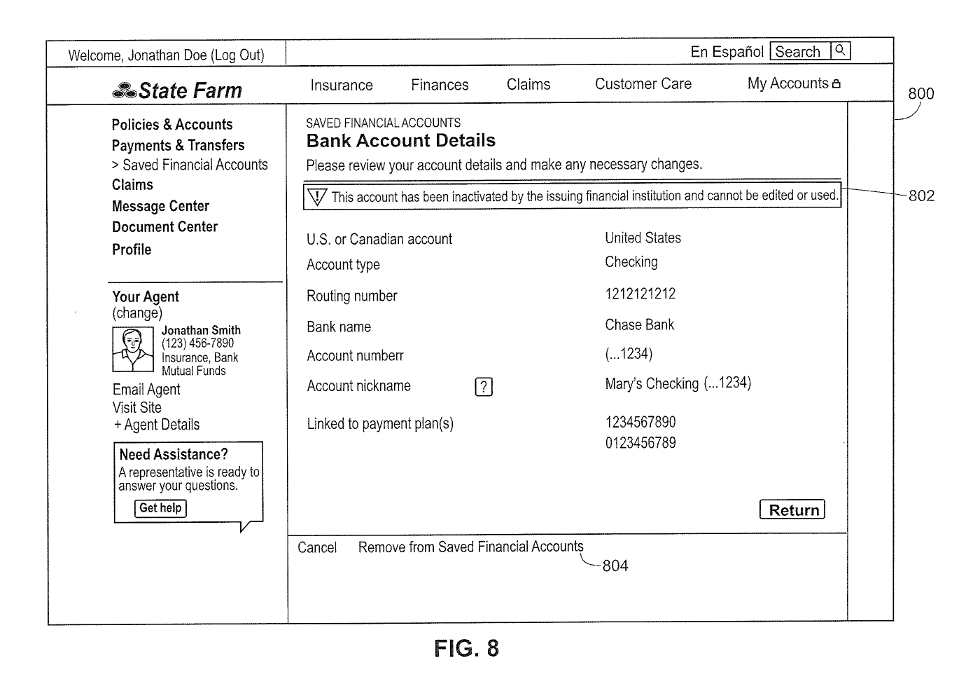

FIG. 8 is a screenshot of another example dashboard page 800 displaying an indication that an external account has been inactivated by the issuing financial institution and cannot be edited or utilized for transactions. For example, the dashboard page 800 may include an alert image 802 informing a user of the account inactivity. In some implementations, the user is provided the option to remove the inavtive account from the corresponding CFPA (e.g., by selecting the option 804).

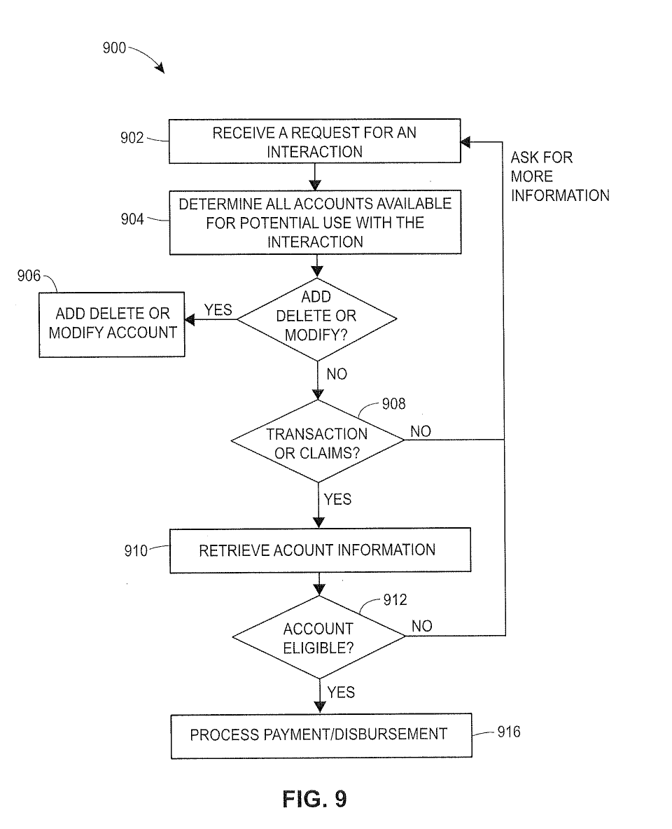

FIG. 9 is a flow diagram of an example method 900 for processing a request for interaction with a financial account system. The example method 900 may be implemented in the the financial account system 200, for example.

A financial account system receives a request, from a user device or financial institution, for example, for an interaction with the financial account system (block 902). The interaction may be any suitable interaction, as discussed above with reference to FIG. 3. Next, all financial accounts available for potential use (e.g. those stored in a financial account database) are determined (block 904).

If the request for an interaction indicates adding, modifying or deleting an account, the flow continues to block 906 where a specific account is added, modified or deleted from the financial account system. For example, the financial account system may remove one or more entries corresponding to the specific account from a financial account database. If, however, the request for an interaction does not indicate adding, modifying, or deleting an account, the flow continues to block 908.

If the request for an interaction indicates a purchase of products or services, a transaction (payment or disbursement), or a processing of claims with respect to a specific account, the flow continues to block 910. Information about the specific account (e.g., balance, account number, etc.) is retrieved from a financial account database based upon a set of pre-defined rules (block 910). Then the specific account is verified to be eligible for the interaction indicated in the request (block 912). When a selected account does not pass verification, presuming additional selected accounts are not available, a system request is made for alternate account selection.

After verification, the payment or disbursement transaction is processed by the financial account system (block 916). This processing may involve purchasing a new product or service, in a scenario. In an alternative scenario, the payment plan flow transaction may involve paying for an existing product or service.

In some implementations, the financial account system is configured to permit a user to pay for services and products on-line by “writing” an electronic check or any other known means for making payments electronically. The financial account system may also provide account information in a pre-populated form within a financial account management tool, thereby saving the user the hassle of data entry, in an implementation.

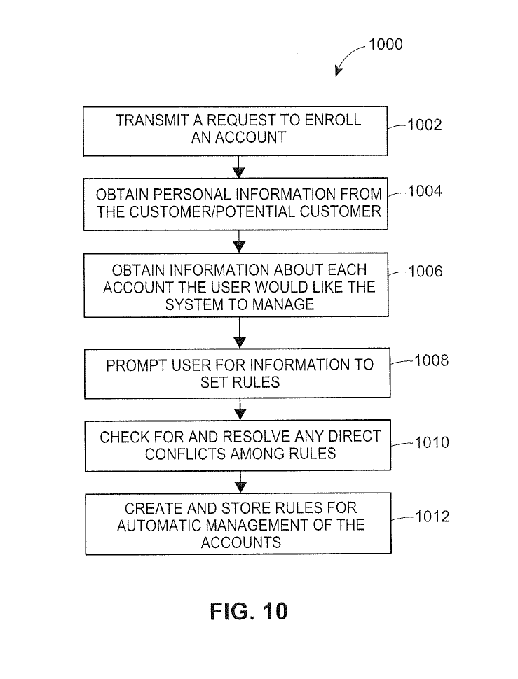

FIG. 10 is a flow diagram of an example method 1000 for adding a financial account to the financial account system (e.g., adding accounts to a financial account database) and defining rules associated with the financial account. The example method 1000 may be implemented in the environment 100, for example.

A user device, such as one of the user devices 104, may transmit a request to place a financial account within the financial account system (block 1002). For example, a user may initiate such a transmission by clicking on a button in a graphical user interface (GUI). A user may be a customer, potential customer, or a customer service representative working on behalf of the system owner, for example.

In response to the request, the financial account system may prompt the user to enter personal information (block 1004). For example, the financial account system may send web pages to a user with prompts for the user's name, age, mailing address, e-mail address, marital status, or other customer information. When the user inputs such information at an input device of a user device, the user device may transmit the personal information back to the financial account system, in an implementation.

After the user enters personal information, the financial account system may prompt the user to enter account information (block 1004) about the account to be added to the financial account system (block 1006). In this regard, the financial account system may send web pages to the user with prompts for the name of the financial institution that maintains the account, the account number, the routing number, and the type of account (e.g., checking, savings, money market, brokerage, liability, etc.), for example. When the user inputs such information at an input device of a user device, the user device may transmit the necessary account information back to the financial account system.

Next, at block 1008, the financial account system may send prompts to the user requesting information that allows the financial account system to build a set of rules to manage the customer's accounts (e.g., with rules system 216). The rules may include default rules as suggested by the financial account system and/or rules customized or newly entered by a user, in an implementation.

In one scenario, the financial account system may First, the rules prompt the user for information that indicates whether the user would like to utilize the system for acquisition of products, servicing of products, transaction processing (e.g., disbursements including claim payouts or dividends, payments) or any other business applications. For example, the financial account system may be configured to recommend (e.g., with a weighing system) that the user consider an internal account instead of an external account, or the rules manager may be configured to recommend that the user consider accounts already known to handle a desired interaction (e.g., the account is sufficiently funded or the account is up-to-date.)

In some implementations, the financial account system may be configured to allow the user to prioritize accounts from which the system should draw or deposit funds. For example, the user may specify that the system should first attempt to draw funds from a savings account and then from a money market account, for a specific transaction. Alternatively, the user may specify that the system should only draw funds from an account if the account has a certain balance, for example.

In one scenario, a user may specify that the financial account system should only draw funds out of the savings account if it has a balance above $10,000, otherwise it should draw funds from the money market account. The user may also specify how much money should be transferred out of a source account in terms of an absolute dollar amount (e.g., transfer no more than $1,000 out of account A), a percentage of the source account balance (e.g., transfer no more than 25% of the balance of account A), or an amount not to cause the source account to fall below a certain amount (e.g., transfer no more than would cause the balance of the source account to fall below $1000). Continuing with the above example scenario, the user may specify that the financial account system should not transfer any more out of the savings account than would cause the savings account to fall below $8,000, and any remainder should be transferred out of the money market account.

The rules manager may prompt the user to identify any accounts for which the user would like the system to track the total amount of deposits over the course of a particular time period, in an implementation. If the user identifies any accounts for which the user would like the system to track the aggregate amount of deposits, the financial account system may prompt a user to identify the target amount the user would like to deposit into the account for the time period. After the user identifies the target amount that the user would like to deposit into the account over the time period, the financial account system may prompt the user to authorize the financial account system to automatically fund the account at the user-specified level by making periodic transfers to the account.

Still further, in the implementation, the user may further configure the financial account system to send the user an alert (e.g., an e-mail message) once a target amount has been deposited in the account, to stop the deposit of funds into the account once a target amount has been deposited, or to send a user an alert notifying the user of any shortage in the target amount at a particular time (e.g., 30 days prior to the end of the user's tax year).

The user may also configure the system to automatically pay bills on corresponding due dates, in an implementation. For example, if the user has a liability account with the company, the financial account system may track the monthly balance of the internal liability account and automatically pay the balance of the account from an external or internal account on the due date of the bill.

Returning to FIG. 5, after the user provides information regarding any date or time based management rules, the financial account system may create a proposed set of rules and scan/check the rules to ensure that there are not direct conflicts among the rules (block 1010). A direct conflict among the rules may occur when two or more rules would have the financial account system execute conflicting actions, in an implementation. For example, a rule that instructs the system to maintain a $10,000 balance in a checking account would directly conflict with a rule to pay any funds in excess of $9,000 from the checking account for a product or service. If the financial account system detects any direct conflicts among the rules, it may prompt the user for information to resolve the conflict, in an embodiment.

The financial account system may also generate web pages, to be displayed on a user device, with the proposed rules for user review, in an implementation. In this case, once the user is satisfied with the set of rules corresponding to the account, the user may cause a user device to transmit a signal indicating user approval of the proposed rules, for example.

Next, the financial account system may store the set of rules in a rules database and send the user a confirmation message (block 1012). At this point, the financial account system is able to automatically manage the customer accounts in accordance with the rules, for example.

Once the user has added an account to the financial account system, the operator of the financial account system, a financial institution, or the user can update the rules at any time by transmitting a request for interaction to change the account management rules, in an implementation. For example, a user may access the financial account system via an online dashboard to add, delete, or modify summarized rules.

In some scenarios, the information transferred between the user and the financial account system can be provided through a human operator, such as an operator of one of the operator terminals 110 (e.g., a customer service representative on the phone or in a contact center, a licensed broker or a licensed financial advisor). For example, a licensed broker or financial advisor can engage the user in a discussion about the management of financial resources and obtain information from the user through a telephone call or a face-to-face meeting. Subsequently, the operator may enter the appropriate information into the financial account system.

After determining the rules for one or more financial account, the financial account system (e.g., with a rules engine) may scan the rules to determine if there is any conflict among the rules, in an implementation. For example, a conflict may occur when execution of one rule would cause the system to violate another rule. If the financial account system, via a rules engine, for example, determines that there is a conflict among rules, the financial account system mayuse a predetermined set of conflict resolution rules to resolve the conflict. For example, the conflict resolution rules may indicate that a date-based rule always takes priority over a balance-based rule or a rule to maintain a minimum balance takes priority over a rule to transfer excess funds out of an account.

Additionally, the financial account system may be configured to allow a user to view the current balance and transaction history of each of the accounts associated with the user at any time by accessing this information using a secure Internet website. The financial account system may also be configured to allow a customer service representative, broker or financial advisor to access this information on-line (e.g., through a public network or an intranet), in an implementation. In this way, a customer service representative, broker or financial advisor is able get a picture of the user's financial resources and spending habits and work to formulate a savings and investment plan tailored for the individual user.

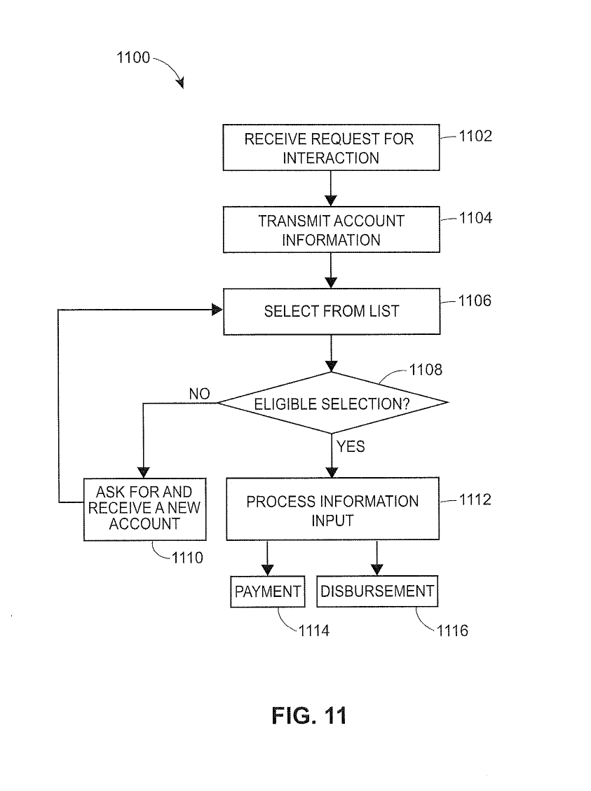

FIG. 11 is a flow chart of an example method 1100 for the operation of a financial account system. The method may be implemented in the financial account system 200, for example.

The method 1100 is initiated upon receiving at least one request for an interaction with the financial account system requiring the utilization of at least one externally-linked account (block 1102). Information (balances, linked payments, etc.) about the at least one externally-linked account is then transmitted to a user device to be displayed in a list and pre-populated (block 1104).

Next, a user selection of the recommended externally-linked account is received (block 1106). In one embodiment, the user may override the selected externally linked account and manually enter a new or stored account for use in a subsequent transaction (not shown). The selected account may also undergo a verification process (not shown) using a rule-based account verification module to determine eligibility (block 1108). If the account is not eligible (e.g., does not have a necessary balance, is not authorized), the flow may continue to block 1110 where a new account may be received.

If the account is eligible, information contained in the request for interaction may be processed to determine if the interaction indicates a payment or disbursement transaction (block 1112). If the interaction indicates a payment transaction, a payment may be processed using rule-based payment plan (block 1114), as discussed above. If the interaction indicates a disbursement transaction, a disbursement may be processed using a rule-based disbursement plan flow (block 1116), as discussed above.

### Additional Considerations

Other embodiments are within the scope of the following claims. For example, an automated system may be configured by the user to transmit a message asking the user's approval, e.g., through an e-mail message or a SMS/SMTP text-message, for a transfer of funds to or from an account when the system detects the account value has reached a certain threshold. Similarly, an automated system may be configured to allow the user to establish rules that cause the system to send a notification message, for example, an e-mail message, when the balance of an account or group of accounts reach a certain threshold.

The invention is operational with numerous general purpose or special purpose computing system environments or configurations. Examples of well-known computing systems, environments and configurations that may be suitable for use include customer computers, server computers, hand-held including smart-phones, tablet or laptop devices, multiprocessor systems, microprocessor-based systems, programmable consumer electronics, network PCs, minicomputers, mainframe computers, distributed computing environments that include any of the above systems or devices, and the like.

As used herein, an input device can be, for example, a keyboard, rollerball, mouse, voice recognition system or other device capable of transmitting information from a user (or customer) to a computer. The input device can also be a touch screen on a wireless telephone, computer or tablet device in which case the user responds to prompts on the display by touching the screen. The user may enter textual information through the input device such as the keyboard or using a virtual keyboard on the touch-screen. In other words, any inputted information may be received from a number of web-enabled devices via a web server connected over a network. In some instances, the web enabled devices may communicate with the network via wireless signals and, in some instances, may communicate with the network via an intervening wireless or wired device, which may be a wireless router, a wireless repeater, a base transceiver station of a mobile telephony provider, etc. In most cases, the network may be the Internet, using an Internet Protocol, but other networks may also be used.

The system's high-level architecture includes both hardware and software applications, as well as various data communications channels for communicating data between the various hardware and software components. The web server may be implemented in one of several known configurations via one or more servers configured to process web-based traffic received via the network and may include load balancing, edge caching, proxy services, authentication services, etc.

The storage (rules database and customer financial data database) may be a part of a data server or may be a separate server with independent memory. The data server may be connected to the web server via a network and may implement the processes described above for implementing and displaying the system and method for integrating and facilitating customer experience.

The data server includes a controller. The controller includes a program memory, a microcontroller(s) or a microprocessor(s) (μP), at least one random-access memory (RAM), and an input/output (I/O) circuit, all of which are interconnected via an address/data bus. In some embodiments, the controller may also include, or otherwise be communicatively connected to, a database or other data storage mechanism. The databases may include data such as account information and rules information. The data server may also include specific routines to render the data into an image for display by a computer or any of the web devices via web server. Any I/O circuit used may include a number of different types of I/O circuits, including but not limited to, additional load balancing equipment, firewalls, etc. The RAM(s) and the program memories may be implemented in a known form of computer storage media, including but not limited to, semiconductor memories, magnetically readable memories, and/or optically readable memories, for example, but does not include transitory media such as carrier waves.

As used herein, rules, instructions, and modules refer to computer-implemented steps for processing information in the system. Instructions can be implemented in software, firmware or hardware and include any type of programmed step undertaken by components of the system. Source code is a text file written by computer programmers (humans) in a programming language. Source code may be written to provide rules, instructions, and algorithms to the system's computer processor/CPU for carrying out a computer function. A computer program constitutes source code and may be stored on a memory/storage medium such as a hard disk or in the rules or customer financial data database. A compiler (also a computer program) may translate the source code, derived from the system default rules or the organization rules or the user provided rules, into binary machine code which the compiler then stores as executable files. An executable file is then executed by one of the system processors/microprocessors causing the computer to perform instructions according to the binary machine code.

Generally speaking, a rule is just a definite and unambiguous procedure for turning some data into new data. This does not in general include any mention of when to “stop” applying the rule (although it might for some rules). An algorithm is a rule put into action to solve some set of very similar problems. There is a clear definition of the set of possible input problems, and a clear definition of the set of possible outputs. The crucial thing is that given any valid input problem, the rule must always halt in some finite time and produce a correct solution to the problem. Thus an algorithm comes with a guarantee that it always solves the problem in a finite time.

The system is comprised of various modules. As can be appreciated by one of ordinary skill in the art, each of the modules comprises various sub-routines, procedures, definitional statements and macros. Each of the modules are typically separately compiled and linked into a single executable program. The processes that are undergone by each of the modules may be arbitrarily redistributed to one of the other modules, combined together in a single module, or made available in, for example, a shareable dynamic link library.

The steps of a method or algorithm or rules or modules described in connection with the embodiments disclosed herein may be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

Those of ordinary skill in the art will appreciate that the various illustrative logical blocks, modules, instructions, rules and algorithm steps described in connection with the embodiments disclosed herein can often be implemented as electronic hardware, computer software, or combinations of both. To clearly illustrate this interchangeability of hardware and software, various illustrative components, blocks, modules, and steps may be described generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the invention. In addition, the grouping of functions within a module, block or step is for ease of description. Specific functions or steps can be moved from one module or block without departing from the invention.

Any various illustrative logical blocks and modules described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration. A microprocessor may be any conventional general purpose single-core or multi-core microprocessor such as a Pentium® processor, a Pentium® Pro processor, ARM®, MIPS®, Power PC®, or ALPHA® processor.

A Local Area Network (LAN) or Wide Area Network (WAN) may be a corporate computing network, including access to the Internet, to which computers and computing devices making up the system are connected. In one embodiment, the LAN conforms to the Transmission Control Protocol/Internet Protocol (TCP/IP) industry standard.

The system may be used in connection with various operating systems such as LINUX, UNIX or MICROSOFT WINDOWS®. The system may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code.

A web browser comprising a web browser user interface may be used to display information (such as textual and graphical information) to a user. The web browser may comprise any type of visual display capable of displaying information received via a network. Examples of web browsers include Microsoft's Internet Explorer browser, Mozilla's Firefox browser, Apple's Safari browser, Google Chrome or any other browsing or application software capable of communicating with a network.

The invention disclosed herein may be implemented as a method, apparatus or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (FPGAs), application-specific integrated circuits (ASICs), complex programmable logic devices (CPLDs); programmable logic arrays (PLAs), microprocessors, or other similar processing devices.

To the extent that any meaning or definition of a term in this document conflicts with any meaning or definition of the same term in a document incorporated by reference, the meaning or definition assigned to that term in this document shall govern. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims. While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

The invention has been described herein using specific embodiments for the purposes of illustration only. It will be readily apparent to one of ordinary skill in the art, however, that the principles of the invention may be embodied in other ways. Therefore, the invention should not be regarded as being limited in scope to the specific embodiments disclosed herein, but instead as being fully commensurate in scope with the following claims.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A computer-implemented method for integrated financial account management by an insurance provider, comprising:
causing, by one or more processors, a visual interface to be displayed on a user device, the interface enabling a customer to update a customer profile, wherein the customer profile includes information about a plurality of financial accounts corresponding to the customer, and wherein the plurality of financial accounts are added to the customer profile by the customer;
receiving, from the user device via a computer network, a first request for a customer profile update interaction from a customer;
in response to the first request for the customer profile update interaction, updating a customer profile, wherein the updating of the customer profile includes at least one of:
modifying, by the one or more processors, at least some of the information about the plurality of financial accounts, or
deleting, by the one or more processors, at least some of the information about the plurality of financial accounts;
transmitting, to the user device via the computer network, at least some of the updated customer profile to the customer;
storing, by the one or more processors, a plurality of sets of customer-defined rules, each one of the plurality of sets of customer-defined rules corresponding to one of the plurality of financial accounts, wherein each of the plurality of sets of customer-defined rules is used to manage payments from and disbursements to the corresponding one of the plurality of financial accounts,
wherein the customer-defined rules are created or modified by the customer;
receiving, from the customer via the computer network, a second request for a financial account interaction indicating a purchase of products or services;
in response to the request for a financial account interaction and in accordance with the at least one of the plurality of sets of customer-defined rules, determining, by the one or more processors, one of the plurality of financial accounts to be used for the purchase of the products or services; and
upon completion of the purchase of the products or services, causing an account balance corresponding to the one of the plurality of financial accounts to be displayed on the visual interface.

2. The computer-implemented method of claim 1, wherein at least one of the first request or the second request is associated with at least one of: viewing a financial profile, making a purchase, requesting a quote, receiving a disbursement, making a new policy purchase, making a policy change, opening a new bank account, making a change to a bank account, applying for a new loan, making a change to a loan, making a loan payment, applying for a new credit card, interacting with PayPal, making a change to a credit card account, making a credit card payment, opening a new mutual fund account, making a change to a mutual fund account, opening a new money market account, making a change to a money market account, initiating ACH type transactions, opening a new retirement account, making a change to a retirement account, making a deposit, making a withdrawal, submitting a fraud report, and reporting claims activity.

3. The computer-implemented method of claim 1, wherein the plurality of financial accounts include at least one of a: deposit account, saving account, checking account, credit union account, credit card account, PayPal account, investment account, or mutual fund account, and wherein the products or services include at least one of insurance products or financial services products.

4. The computer-implemented method of claim 1, wherein determining the one of the plurality of financial accounts to be used for the purchase of the products or services includes automatically determining the one of the plurality of financial accounts based on at least one of:
a first record in the information about the plurality of financial accounts indicating a last financial account used by the customer,
a second record in the information about the plurality of financial accounts indicating one or more active financial accounts with a sufficient balance, or
a third record in the information about the plurality of financial accounts indicating one or more verified financial accounts;
verifying, with the one or more processors, the eligibility of the one of the plurality of financial accounts.

5. The computer-implemented method of claim 4, wherein verifying the eligibility of the one of the plurality of financial accounts includes determining that the one of the plurality of the financial accounts lacks eligibility.

6. The computer-implemented method of claim 1, wherein the information about a plurality of financial accounts includes an interaction history of the customer.

7. (canceled)

8. The computer-implemented method of claim 4, further comprising initiating, with the one or more processors, a payment or a disbursement from the verified one of the plurality of financial accounts toward the products or services.

9. (canceled)

10. The computer-implemented method of claim 8, wherein the disbursement includes claims payouts and dividends payments.

11. The computer-implemented method of claim 1, further comprising automatically scanning, with the one or more processors, for rules conflicts to identify a rules conflict.

12. The method of claim 11, further comprising, in response to scanning for rules conflicts performing one of:
when a rules conflict is identified, resolving, with the one or more processors, the identified rules conflict, and
when no rules conflicts have been identified, continuing to store the sets of customer-defined rules as they presently exist.

13. The method of claim 1, further comprising storing, with one or more processors, default system rules that are unaltered by the customer and customized rules that have been altered by the customer.

14. A system for integrating and facilitating customer experience, comprising:
a memory; and
one or more processors disposed in communication with said memory,
wherein, when executed by the one or more processors, a plurality of computer-executable instructions stored in the memory cause the one or more processors to:
cause a visual interface to be displayed on a user device, the interface the interface enabling a customer to update a customer profile, wherein the customer profile includes information about a plurality of financial accounts corresponding to the customer, and wherein the plurality of financial accounts are added to the customer profile by the customer;
receive, via a computer network, a first request for a customer profile update interaction from a customer;
in response to the first request for the customer profile update interaction, update a customer profile, wherein the updating of the customer profile includes at least one of:
modifying at least some of the information about the plurality of financial accounts, or
deleting at least some of the information about the plurality of financial accounts;
transmit, via the computer network, at least some of the updated customer profile to the customer;
store a plurality of sets of customer-defined rules, each of the plurality of sets of customer-defined rules corresponding to one of the plurality of financial accounts, wherein each of the plurality of sets of customer-defined rules is used to manage payments from and disbursements to the corresponding one of the plurality of financial accounts,
wherein the customer-defined rules are created or modified by the customer;
receive, from the customer via the computer network, a second request for a financial account interaction indicating a purchase of products or services;
in response to the request for a financial account interaction and in accordance with at least one of the plurality of sets of customer-defined rules, determine one of the plurality of financial accounts to be used for the purchase of the products or services; and
upon completion of the purchase of the products or services, cause an account balance corresponding to the one of the plurality of financial accounts to be displayed on the interface.

15. The system of claim 14, wherein the first request and the second request are associated with at least one of:
viewing a financial profile, making a purchase, requesting a quote, receiving a disbursement, making a new policy purchase, making a policy change, opening a new bank account, making a change to a bank account, applying for a new loan, making a change to a loan, making a loan payment, applying for a new credit card, interacting with PayPal, making a change to a credit card account, making a credit card payment, opening a new mutual fund account, making a change to a mutual fund account, opening a new money market account, making a change to a money market account, initiating ACH type transactions, opening a new retirement account, making a change to a retirement account, making a deposit, making a withdrawal, submitting a fraud report, and reporting claims activity.

16. (canceled)

17. The system of claim 14, wherein the plurality of computer-executable instructions further cause the one or more processors to:
automatically scan for rule conflicts, and
upon identifying a rules conflict in the scanning for rules conflicts, resolve the identified rules conflict.

18. A non-transitory computer-readable storage medium storing processor-executable instructions to:
cause a visual interface to be displayed on a user device, the interface the interface enabling a customer to update a customer profile, wherein the customer profile includes information about a plurality of financial accounts corresponding to the customer, and wherein the plurality of financial accounts are added to the customer profile by the customer;
receive, via a computer network, a first request for a customer profile update interaction from a customer;
in response to the first request for the customer profile update interaction, update a customer profile, wherein the updating of the customer profile includes at least one of:
modifying-at least some of the information about the plurality of financial accounts, or
deleting at least some of the information about the plurality of financial accounts;
transmit, via the computer network, at least some of the updated customer profile to the customer;
store a plurality of sets of customer-defined rules, each of the plurality of sets of customer-defined rules corresponding to one of the plurality of financial accounts, wherein the plurality of sets of customer-defined rules are used to manage payments from and disbursements to each of the plurality of financial accounts,
wherein the customer-defined rules are created or modified by the customer;
receive, from the customer via the computer network, a second request for a financial account interaction indicating a purchase of products or services;
in response to the request for a financial account interaction and in accordance with the at least one of the plurality of sets of customer-defined rules, determine one of the plurality of financial accounts to be used for the purchase of the products or services; and
upon completion of the purchase of the products or services, cause an account balance corresponding to the one of the plurality of financial accounts to be displayed on the interface.

19. (canceled)

20. The computer-implemented method of claim 5, further comprising, in response to determining that the one of the plurality of financial account lacks eligibility, sending, via the computer network, a prompt to the customer for a selection of a different one of the plurality of financial accounts.

21. The computer-implemented method of claim 1, wherein the visual interface further enables the user to purchase insurance products from the insurance provider.

22. The computer-implemented method of claim 1, wherein the visual interface enables the user to view insurance claims processed by the insurance provider.

23. The computer-implemented method of claim 1, wherein the visual interface depicts an indication that one of the plurality of financial accounts is no longer active.

24. The computer-implemented method of claim 1, wherein the visual interface depicts an indication of a payment plan to which at least one of the plurality of financial accounts is linked.
